(19) United States
(12) Patent Application Publication
(10) Pub. No.: US 2016/0140634 A1
(43) Pub. Date: May 19, 2016

(54) SYSTEM, METHOD AND NON-TRANSITORY COMPUTER READABLE MEDIUM FOR E-COMMERCE REPUTATION ANALYSIS

(71) Applicant: INSTITUTE FOR INFORMATION INDUSTRY, TAIPEI (TW)

(72) Inventors: Ping-Che YANG, Kaohsiung City (TW); Hsiang-Lun LIN, Taipei City (TW); Wen-Tai HSIEH, Taipei City (TW)

(21) Appl. No.: 14/555,702

(22) Filed: Nov. 28, 2014

(30) Foreign Application Priority Data
Nov. 17, 2014 (TW) 103139791

(51) Int. Cl. G06Q 30/06; G06F 17/30

(52) U.S. Cl. CPC G06Q 30/0609; G06F 17/30528; G06F 17/3053

(57) ABSTRACT

An e-commerce reputation analysis system includes a comment data capturing module, a keyword retrieving module, a sentiment analysis module and a reputation analysis module. The comment data capturing module captures comment data from an e-commerce platform according to an analysis item. The keyword retrieving module retrieves keywords from the comment data. The sentiment analysis module compares each keyword with sentiment groups. When a first feature phrase of feature phrases of the sentiment groups matches with a first keyword of the keywords, the sentiment analysis module determines that the sentiment group having the first feature phase is corresponding to the first keyword, and increases a rating of the sentiment group corresponding to the first keyword. The reputation analysis module selects first sentiment groups corresponding to the analysis item from the sentiment groups,and statistically sums the ratings of the first sentiment groups.

This application claims priority to Taiwan Application Serial Number 103139791, filed Nov. 17, 2014, which is herein incorporated by reference.

### BACKGROUND

1. Field of Disclosure

The disclosure relates to an e-commerce reputation analysis system and an e-commerce reputation analysis method, and more particularly, to a system and a method for performing an e-commerce reputation analysis according rating data.

2. Description of Related Art

Recently, with the advance of network techniques, the appearance of an e-commerce platform (such as Taobao or PChome Online Shopping, etc.) provides a new consumption pattern to consumers. The consumers may search for and obtain the desired merchandise from many e-commerce platforms merely through Internet connections, thereby making shopping more convenient. Therefore, more and more consumers prefer to use such a consumption pattern to do shopping.

Although the e-commerce platform provides a convenient consumption pattern, yet as the e-commerce platform becomes larger, it becomes not easy to perform an overall reputation analysis on the e-commerce platform and to perform a reputation analysis on a specific merchandise or activity. In general, many consumers will comment on or evaluate their purchased merchandise. Because there are too many sellers or merchandise and the comment data are not systematically generated and also with no specific formats, it is very difficult to perform statistics or analysis on the comment data to generate a reputation analysis with respect to a specific merchandise or activity. Thus, sellers and stores on the e-commerce platform cannot obtain the reputation of the merchandise sold on the e-commerce platform, and fail to take a corresponding action.

Hence, how to provide an effective analysis for the reputation of the E-commerce platform is an issue desired to be solved by those in this industry.

### SUMMARY

One aspect of the disclosure is to provide an e-commerce reputation analysis system. The e-commerce reputation analysis system includes a comment data capturing module, a keyword retrieving module, a sentiment analysis module and a reputation analysis module. The comment data capturing module is configured to capture comment data from an e-commerce platform according to an analysis item. The keyword retrieving module is configured to retrieve keywords in the comment data. The sentiment analysis module includes sentiment groups, each of the sentiment groups including feature phrases, in which the sentiment analysis module is configured to compare each of the keywords with the sentiment groups, and when a first feature phrase of the feature phrases in the sentiment groups matches with a first keyword of the keywords, the sentiment analysis module determines that the sentiment group having the first feature is a sentiment group corresponding to the first keyword, and increases a rating of the sentiment group corresponding to the first keyword. The reputation analysis module is configured to select first sentiment groups corresponding to the analysis item from the sentiment groups, and sums the ratings of the first sentiment groups.

Another aspect of the disclosure is to provide an e-commerce reputation analysis method. The e-commerce reputation analysis method includes capturing comment data from an e-commerce platform according to an analysis item; retrieving keywords in the comment data; comparing each of the keywords with the sentiment groups, wherein each of the sentiment groups comprises feature phrases; determining that the sentiment group having the first feature is a sentiment group corresponding to the first keyword when a first feature phrase of the feature phrases in the sentiment groups matches with a first keyword of the keywords; increasing a rating of the sentiment group corresponding to the first keyword; selecting first sentiment groups corresponding to the analysis item from the sentiment groups; and summing the ratings of the first sentiment groups.

Another aspect of the disclosure is to provide a non-transitory computer readable medium storing a computer program performing an e-commerce reputation analysis method. The e-commerce reputation analysis method includes: capturing comment data from an e-commerce platform according to an analysis item; retrieving keywords in the comment data; comparing each of the keywords with the sentiment groups, wherein each of the sentiment groups includes feature phrases; determining that the sentiment group having the first feature is a sentiment group corresponding to the first keyword when a first feature phrase of the feature phrases in the sentiment groups matches with a first keyword of the keywords; increasing a rating of the sentiment group corresponding to the first keyword; selecting first sentiment groups corresponding to the analysis item from the sentiment groups; and summing the ratings of the first sentiment groups.

### BRIEF DESCRIPTION OF THE DRAWINGS

The disclosure can he more fully understood by reading the following detailed description of the embodiment, with reference made to the accompanying drawings as follows:

FIG. 1 illustrates a schematic block diagram of an e-commerce reputation analysis system according to one embodiment of the disclosure; and

FIG. 2 illustrates a flow chart of an e-commerce reputation analysis method according to one embodiment of the disclosure.

### DETAILED DESCRIPTION

Reference will now be made in detail to embodiments of the disclosure, examples of which are illustrated in the accompanying drawings. However, the embodiments do not intend to limit the scope covered by the present disclosure, and the descriptions regarding structures and operation do not limit their operation sequence. Any devices or structures formed by elements re-combinations and having equivalent effects are all within the scope covered by the present disclosure. Wherever possible, the same reference numbers are used in the drawings and the description to refer to the same or like parts.

It will be understood that, although the terms “first,” “second,” etc., may be used herein to describe various elements, these elements should not be limited by these terms. These terms are used to distinguish one element from another, and do not intend to point out a specific order or sequence. For example, a first element could be termed a second element, and, similarly, a second element could be termed a first element, without departing from the scope of the embodiments.

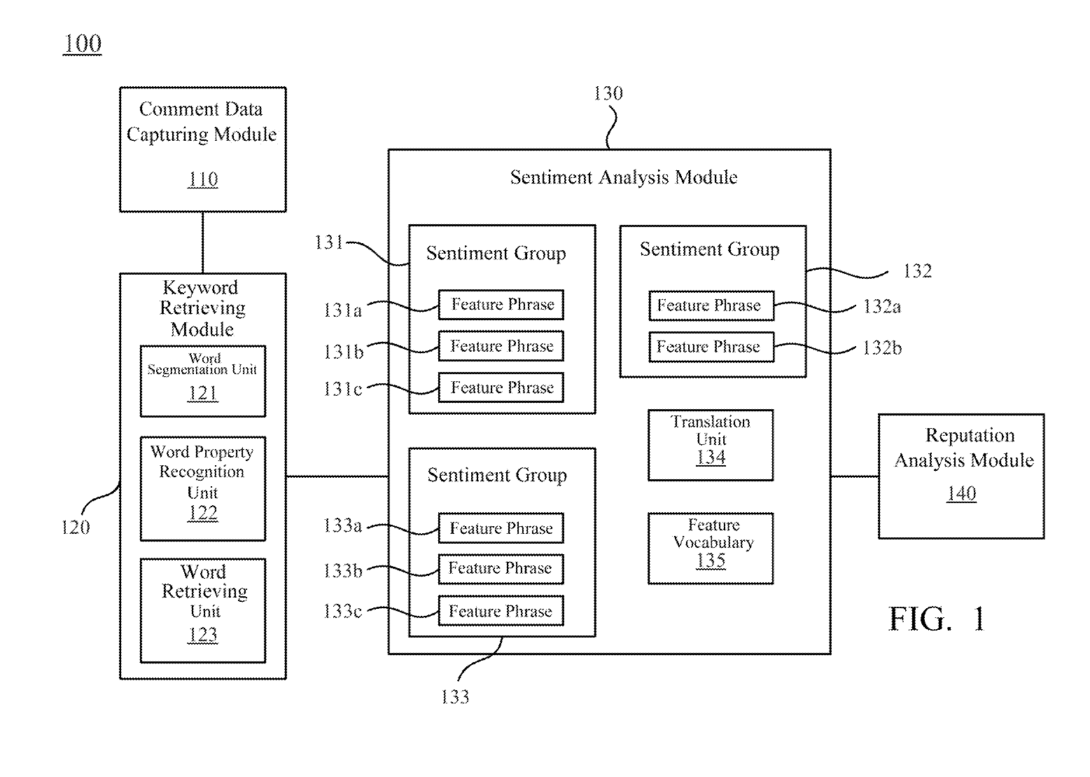

Referring to FIG. 1, FIG. 1 illustrates a schematic block diagram of an e-commerce reputation analysis system 100 according to one embodiment of the disclosure. The e-commerce reputation analysis system 100 includes a comment data capturing module 110, a keyword retrieving module 120, a sentiment analysis module 130 and a reputation analysis module 140. The e-commerce reputation analysis system 100 is applicable to any e-commerce platform such as Taobao Net, Yahoo Auction, PChome Online Shopping, etc. The e-commerce reputation analysis system 100 may perform statistics and analysis on the comment data regarding a specific e-commerce platform according to an analysis item chosen by a user. In one embodiment, the analysis item may include merchandise, a seller or an activity on the e-commerce platform.

Concretely speaking, a user may use the e-commerce reputation analysis system 100 to perform statistics and analysis on all of the comment data regarding a merchandise (such as an iphone 6), a seller or an activity (such as Valentine's Sale) on an e-commerce platform (such as Taobao Net), thereby understanding the reputation of the merchandise, the seller or the activity on the e-commerce platform. For example, if desiring to know the overall reputation of a certain seller on the Taobao Net, a user may use the e-commerce reputation analysis system 100 to collect all of the comment data regarding the certain seller, and perform comparison, analysis and statistics. Thus, the user can understand what the overall reputation of the seller is, such as the reputations of having a high C/P ratio (Cost/Performance Ratio) of the merchandise sold by the seller, having an ordinary service attitude, and having slow delivery speed, etc.

In this embodiment, the comment data capturing module 110 is used to capture comment data from an e-commerce platform according to an analysis item. In one embodiment, the comment data capturing module 110 may obtain the comment data corresponding to the analysis item by performing a whole text search on the e-commerce platform. The keyword retrieving module 120 is used to retrieve keywords in the comment data.

The sentiment analysis module 130 includes sentiment groups 131-133. For the convenience of explanation, in this embodiment, the number of the sentiment groups is three, but is not limited thereto. In other word those who are skilled in the art may increase or decrease the number of the sentiment groups according to actual requirements. Each of the sentiment groups 131-133 includes plural feature phrases. In this embodiment, the sentiment group 131 includes feature phrases 131a-131c, the sentiment group 132 includes feature phrases 132a-132b, and the sentiment group 133 includes feature phrases 133a-133c. However, this embodiment is not limited thereto.

In one embodiment, the sentiment groups 131-133 and their feature phrases 131a-131c, 132a-132b and 133a-133c can be built and stored in advance by a technical person; can be built by training the sentiment groups and feature phrases in other cases which have been analyzed; or can be built in advance by the e-commerce reputation analysis system 100 and then provided for a user to select. However, this embodiment is not limited thereto.

On the other hand, in one embodiment, after the feature phrases in the sentiment groups is compared with a keyword retrieved from the comment data, the e-commerce reputation analysis system 100 may add the keyword as a new feature phrase; or may translate the keyword retrieved from the comment data in another language and then add the keyword as a new feature phrase. The details of this portion will be explained later in the subsequent embodiments.

The sentiment analysis module 130 is used to compare each of the keywords with the sentiment groups 131-133, i.e. with the feature phrases 131a-131c, 132a-132b and 133a-133c in the sentiment groups 131-133. When a first feature phrase of the feature phrases 131a-131c, 132a-132b and 133a-133c in the sentiment groups 131-133 matches with a first keyword of the keywords, the sentiment analysis module 130 determines that the sentiment group having the first feature is a sentiment group corresponding to the first keyword, and increases a rating of the sentiment group corresponding to the first keyword.

In this embodiment, when the e-commerce reputation analysis system 100 is performing reputation analysis, the feature phrases in the sentiment groups 131-133 are respectfully corresponding to reputation analysis results of the user's sentiments. That is, the e-commerce reputation analysis system 100 may first select several sentiment groups for being used as reputation analysis results; or a user may first select several sentiment groups from the original sentiment groups for being used as reputation analysis results. Then, the sentiment analysis module 130 can compare each keyword (i.e. a feature word) of the comment data with the feature phrases of the selected sentiment groups. If the feature word of the comment data has a similar or same meaning to the feature phrase of a certain sentiment group, the sentiment analysis module 130 can determine that the comment data is corresponding to the certain sentiment group, and increases a rating of the certain sentiment group.

For example, the sentiment group 132 can be corresponding to the reputation of material flow service of a seller, and the feature phrase 132a may be “fast delivery”, and the feature phrase 132b may be “fast refund”. When the key words retrieved from the comment data by the keyword retrieving module 120 include “delivery” and “fast”, the sentiment analysis module 130 can determine that the key words “delivery” and “fast” match with the feature phrase 132a in the sentiment group 132. Then, the sentiment analysis module 130 determines that the sentiment group 132 having the feature phrase 132a is a sentiment group corresponding to the key words “delivery” and “fast”, and increases the rating of the sentiment group 132, i.e. increases the rating of the reputation of material flow service of the seller.

In one embodiment, among the sentiment groups selected by the e-commerce reputation analysis system 100 or the user, ratings of some sentiment groups may be zero, and those sentiment groups will not appear in the final reputation analysis results.

The reputation analysis module 140 is used to select plural first sentiment groups corresponding to the analysis item from the sentiment groups 131-133, and sums the respective ratings of the first sentiment groups. For example, if the analysis item is with respect to a certain seller on the e-commerce platform, i.e. if the e-commerce reputation analysis system 100 is applied to perform reputation analysis on a certain seller on the e-commerce platform, the reputation analysis module 140 may select all sentiment groups (for example, the sentiment groups 132, 133) corresponding to the reputation of the seller from the sentiment groups (for example, the sentiment groups 131-133), and sums the rating of the sentiment group 132 and the rating of the sentiment group 133 respectively. It is noted that, for the convenience of explanation, the number of the sentiment groups corresponding to the seller is two, but those who are skilled in the art may understand that different analysis items (such as merchandise, sellers or activities) are corresponding to different actual conditions, and thus the number of corresponding sentiment groups (i.e. corresponding to the reputation regarding the analysis item) may one or more than two.

Accordingly, the user can use the e-commerce reputation analysis system 100 to understand a rating of reputation regarding a certain analysis item on a certain e-commerce platform, and uses the rating to understand the consumption or sale analysis results with respect to the analysis item of the e-commerce platform.

In one embodiment, the sentiment analysis module 130 further includes a translation unit 134 and a feature vocabulary 135. The translation unit 134 is sued to translate a phrase in a first language to another phrase in second language which is different from the first language. The feature vocabulary 135 is used to store all of the feature phrases 131a-131c, 132a-132b and 133a-133c in the sentiment groups 131-133.

In one embodiment, when none of the feature phrases 131a-133c in the sentiment groups 131-133 match with the first keyword of the keywords, the sentiment analysis module 130 may translate the first keyword via the translation unit 134, thereby generating a corresponding translated phrase in a language different from that used by the first keyword. Then, the sentiment analysis module 130 may perform a similarity comparison between the corresponding translated phrase of the first keyword and the feature phrases 131a-133c in the sentiment groups 131-133, thereby generating a comparison result.

In one embodiment, corresponding translated phrases of the feature phrases 131a-133c contained in the sentiment groups 131-133 in different languages can be stored in advance, and provided for the sentiment analysis module 130 to perform the similarity comparison on the corresponding translated phrase which is translated from the first keyword in a different language.

In another embodiment, the sentiment analysis module 130 may use the translation unit 134 to translate all of the feature phrases 131a-131c, 132a-132b and 133a-133c contained in the sentiment groups 131-133, and then perform the similarity comparison between the corresponding translated phrase corresponding to the first keyword and the translated feature phrases 131a-131c, 132a-132b and 133a-133c.

Thereafter, the sentiment analysis module 130 may determine if there exists the sentiment group corresponding to the first keyword according to the comparison result after the comparison between the keywords in the comment data and the sentiment groups 131-133. When determining that there exists the sentiment group corresponding to the first keyword according to the comparison result, the sentiment analysis module 130 increases the rating of the sentiment group corresponding to the first keyword.

In practices, two comments with the same (or similar) meanings may be expressed by different phrases. For example, a comment that means “fast delivery” can be expressed by two different Chinese phrases, e.g., “ [symbol] [symbol] ” (fast delivery) and “ [symbol] ”. These two Chinese phrases indicate the same meanings, i.e., “fast delivery”, but are not completely matched' to each other in a traditional wording comparison.

In the aforementioned example, if the keywords retrieved from the comment data by the keyword retrieving module 120 include Chinese phrases “ [symbol] ” and “ [symbol] ”, because the feature phrase 132a is a Chinese phrase “ [symbol] [symbol] ”, the sentiment analysis module 130 fails to determine that “ [symbol] ” matches with “ [symbol] ”. Therefore, the sentiment analysis module 130 may first use the translation unit 134 to translate “ [symbol] ” into a corresponding translated phase (for example, “fast”) in a language (for example, English) different from Chinese. In this embodiment, the feature phrase 132a contained in the sentiment group 132 further has a English phrase (for example, “quick”) corresponding to “ [symbol] ”, or the sentiment analysis module 130 also may translate the feature phrase 132a “ [symbol] ” contained in the sentiment group 132 into a English phrase (for example, “quick”) corresponding to “ [symbol] ”. Thereafter, the sentiment analysis module 130 may conduct synonym analysis on the corresponding translated phrase and the feature phrases 131a-131c, 132a-132b and 133a-133c contained in the sentiment groups 131-133, so as to perform the similarity comparison therebetween, thus determining that “fast” and “quick” are of the same meaning. Thus, the sentiment analysis module 130 can determine that the first feature phrase “ [symbol] ” contained in the sentiment group 132 matches with the first keyword “ [symbol] ”.

Consequently, the sentiment analysis module 130 can determine that the sentiment group 132 with the feature phrase 132a is a sentiment group corresponding to the keywords “ [symbol] ” and “ [symbol] ”, and increases the rating of the sentiment group 132.

In another specific embodiment, the sentiment analysis module 130 may perform the similarity comparison between the corresponding translated phrase and the feature phrases 131a-131c, 132a-132b and 133a-133c contained in the sentiment groups 131-133 by using a unigram or bigram method. In an example with “very fast” and “very quick”, the corresponding translated phrase “very fast” is segmented into unigram segments, “v”, “e”, “r”, “y”, “f”, “a”, “s” and “t”, or into bigram segments, “ve”, “er”, “ar”, “ry”, “yf”, “fa”, “as” and “st”. In the same manner, the corresponding translated phrase “very quick” is segmented into unigram and bigram segments as “v”, “e”, “r”, “y”, “q”, “u”, “i”, “c”, “k, “ve”, “er”, . . . . The sentiment analysis module 130 may compare each segment of the corresponding translated phrase with each segment of the feature phrases in the sentiment groups, and divide the total counts of the segments simultaneously appearing in the corresponding translated phrase and the sentiment groups by the total number of the segments of the corresponding translated phrase, thereby obtaining a probability (which is 100% in this example). Then, the sentiment analysis module 130 may determine if the probability is greater than the predetermined probability, thereby determining if the first keywords “ [symbol] ” and “ [symbol] ” match with the feature phrase 132a “ [symbol] ” [symbol] ” in the sentiment group 132. When the calculated probability is greater than the predetermined probability (for example, 75%), the sentiment analysis module 130 determines that there exists the sentiment group 132 corresponding to the first keywords (“ [symbol] ” and “ [symbol] ”), i.e. the first keywords “ [symbol] ” and “ [symbol] ” match with the feature phrase 132a “ [symbol] ” in the sentiment group 132.

When determining that there exists the sentiment group corresponding to the first keyword according to the comparison result (for example, the calculated probability is greater then the pre-determined probability), the sentiment analysis module 130 may set the first keyword as a feature phrase, i.e. set the first keyword as a new feature phrase, and add the second feature phrase to the sentiment group 132 corresponding to the first keyword, thereby updating the feature phrases included in the sentiment group 132, and store the second phrase into the feature vocabulary 135.

On the other hand, when determining that there not exists the sentiment group corresponding to the first keyword according to the comparison result, the sentiment analysis module 130 deletes the first keyword from the keywords retrieved by the keyword retrieving module 120. In other words, when the sentiment group corresponding to the first keyword does not exist, meaning that the first keyword is meaningless or does not match with the feature of the analysis item, there is no need to perform reputation analysis on the first keyword.

In one embodiment, the keyword retrieving module 120 includes a word segmentation unit 121, a word property recognition unit 122 and a word retrieving unit 123. The word segmentation unit 121 is used to perform a word segmentation algorithm on contents of the comment data, thereby obtaining phrase segments. The word property recognition unit 122 is used to recognize properties of the phrase segments. The word retrieving unit 123 is used to retrieve the phrase segments having nouns and adjectives as keyword candidates, and to retrieve the keywords from the keyword candidates.

In one embodiment, the word retrieving unit 113 retrieves the keywords according to appearing frequencies of the keyword candidates and correlations between the keyword candidates and the analysis item. Consequently, the comment data capturing module 110 can eliminate the phrase segments irreverent to the analysis item, and set the phrase segments related to the analysis item as the keywords for comparison and analysis, thereby the comparison efficiency of the sentiment analysis module 130 and the analysis efficiency of the reputation analysis module 140.

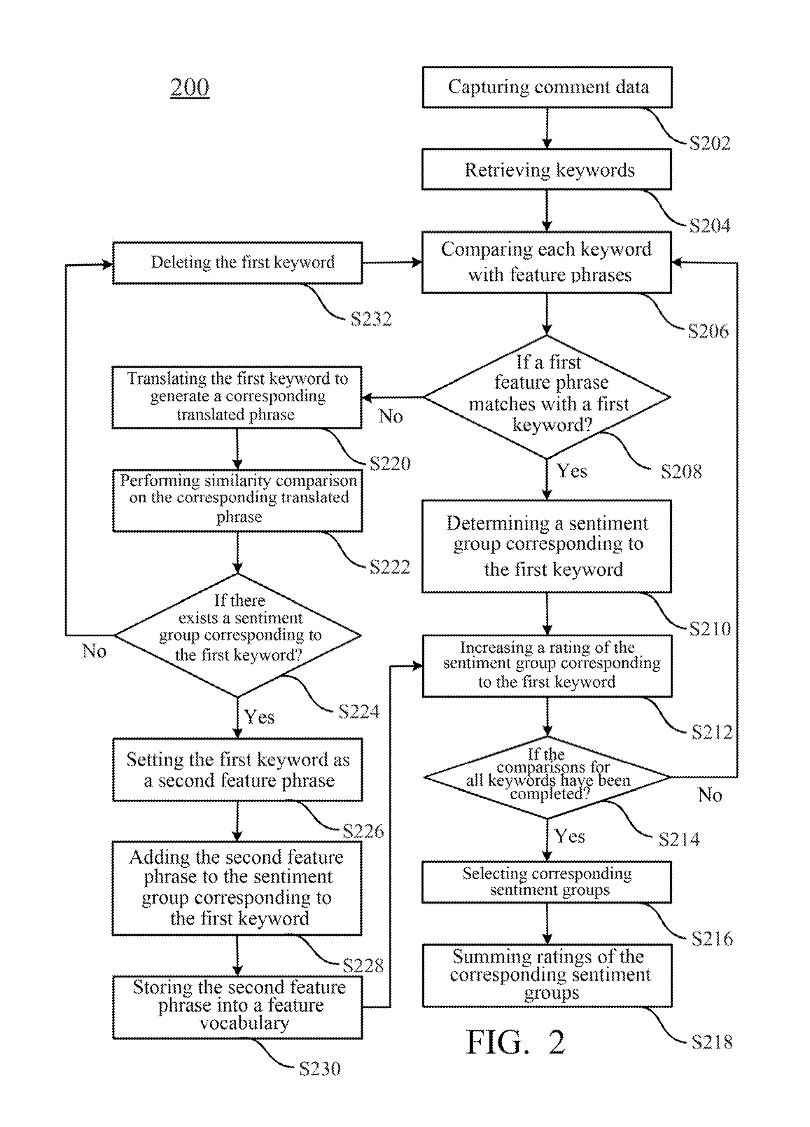

Referring to FIG. 1 and FIG. 2 simultaneously, FIG. 2 illustrates a flow chart of an e-commerce reputation analysis method 200 according to one embodiment of the disclosure. The e-commerce reputation analysis method 200 can be implemented as a computer program product (such as a computer program), and stored in a non-transitory computer readable medium. After loading in the non-transitory computer readable medium, a computer performs the e-commerce reputation analysis method 200. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, a network accessible library or another type of media/machine-readable medium suitable for storing electronic instructions.

At first, in step S202, comment data are captured from an e-commerce platform by the comment data capturing module 110 according to an analysis item. In one embodiment, the comment data capturing module 110 may obtain the comment data corresponding the analysis item by performing a whole text search on the e-commerce platform.

Then, in step S204, keywords in the comment data are retrieved by the keyword retrieving module 120. In one embodiment, the step S204 may include performing a word segmentation algorithm on contents of the comment data, thereby obtaining plural phrase segments; recognizing properties of the phrase segments; retrieving the phrase segments having nouns and adjectives as plural keyword candidates; and retrieving the keywords from the keyword candidates. Further, a user may retrieve the keywords according to appearing frequencies of the keyword candidates and correlations between the keyword candidates and the analysis item.

Thereafter, in step S206, each of the keywords is compared with the sentiment groups 131-133 by the sentiment analysis module 130. Similarly, the sentiment groups 131-133 and their feature phrases 131a-131c, 132a-132b and 133a-133c can be built and stored in advance by a technical person; can be built by training the sentiment groups and feature phrases in other cases which have been analyzed; or can be built in advance by the e-commerce reputation analysis system 100 and then provided for a user to select. However, this embodiment is not limited thereto.

Thereafter, step S208 is performed to determine if a first feature phrase of the feature phrases 131a-131c, 132a-132b and 133a-133c in the sentiment groups 131-133 matches with a first keyword of the keywords, i.e. to determine if a feature phrase in the comment data has the same or similar meaning with a feature phrase in a certain sentiment group, thereby determining if the comment data is corresponding to the sentiment group.

When there exists the first feature phrase of the feature phrases 131a-131c, 132a-132b and 133a-133c in the sentiment groups 131-133 matching with a first keyword of the keywords (the result of step S208 is “yes”), step S210 is performed to determine that the sentiment group having the first feature phrase is a sentiment group corresponding to the first keyword. Then, step S212 is performed to increase a rating of the sentiment group corresponding to the first keyword.

Thereafter, step S214 is performed to determine if the comparisons for all of the keywords retrieved from the comment data have been completed, i.e. to determine if each of the keywords has completed the step for searching its corresponding sentiment group. When there still are some keywords which have not finished their comparisons, step S206 is returned. When all of the keys have finished their comparisons, step S216 is performed.

In step S216, plural first sentiment groups corresponding to the analysis item are selected from the sentiment groups 131-133. Then, step S218 is performed to sum the respective ratings of the first sentiment groups.

Accordingly, the user can use the e-commerce reputation analysis method 200 to understand a rating of reputation regarding a certain analysis item on a certain e-commerce platform, and uses the rating to understand the consumption or sale analysis results with respect to the analysis item of the e-commerce platform,

In step S208, when none of the feature phrases 131a-131c, 132a-132b and 133a-133c in the sentiment groups 131-133 match with a first keyword of the keywords (the result of step S208 is “no”) step S220 is performed. In step S220, the first keyword is translated by the translation unit 134, thereby generating a corresponding translated phrase in a language different from that used by the first keyword. Then, in step S222, a similarity comparison is performed between the corresponding translated phrase and the feature phrases 131a-131c, 132a-132b and 133a-133c in the sentiment groups 131-133 by he sentiment analysis module 130, thereby generating a comparison result.

In one embodiment, the similarity comparison between the corresponding translated phrase and the feature phrases 131a-131c, 132a-132b and 133a-133c in the sentiment groups 131-133 can be performed according to the aforementioned embodiments, and are described again herein.

In one embodiment, the similarity comparison between the corresponding translated phrase and the feature phrases 131a-131c, 132a-132b and 133a-133c contained in the sentiment groups 131-133 can be performed by using the unigram or bigram method according to the aforementioned embodiments, and are described again herein.

Thereafter, step S224 is performed to determine if there exists a sentiment group corresponding to the first keyword according to the comparison result. When the comparison result shows that the sentiment group corresponding to the first keyword exists (the result of step S224 is “yes”), step S226 is performed to set the first keyword as a second feature phrase other words, the first keyword is set as a new feature phrase. Then, in step S228, the second feature phrase is added to the sentiment group corresponding to the first keyword, thereby updating the feature phrases included in the sentiment group corresponding to the first keyword.

Thereafter, step S230 is performed to store the second phrase into the feature vocabulary 135. Then, step S212 is returned and performed to increase the rating of the sentiment group corresponding to the first keyword. It is noted that any of the steps S228-S230 may be added, deleted or re-sequenced according to actual requirements, and thus embodiments of the present disclosure are not limited thereto.

Step S224 is returned. When the comparison result shows that there not exists the sentiment group corresponding to the first keyword (the result of step S224 is “no”), step S232 is performed to delete the first keyword from the keywords retrieved by the keyword retrieving module 120, and step S206 is returned.

The aforementioned e-commerce reputation analysis system 100 and e-commerce reputation analysis method 200 can be implemented or performed by software, hardware and/or firmware. For example, if the execution speed and accuracy are primarily considered, hardware and/or firmware are mainly selected and used to implement the e-commerce reputation analysis system 100; if the design flexibility is primarily considered, software is mainly selected and used to implement the e-commerce reputation analysis system 100; or software, hardware and firmware can be simultaneously selected and collaborated to implement the e-commerce reputation analysis system 100. It should be understood that the aforementioned examples do not involve the superiority and inferiority, and also do not intend the limit the present disclosure. Those who are skilled should be able to flexibly select the implementation tool according to actual requirements.

To sum up, in the disclosure, by using the e-commerce reputation analysis system and method provided by the present disclosure to effectively retrieve and compare keywords retrieved from comment data, a user can understand a rating of reputation regarding a certain analysis item of a certain e-commerce platform, and decide if he or she is going to buy or sell merchandise on the e-commerce platform according to the rating of reputation.

Although the disclosure has been described in considerable detail with reference to certain embodiments thereof, other embodiments are possible. It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims.

What is claimed is:

1. An e-commerce reputation analysis system, comprising:
a comment data capturing module configured to capture comment data from an e-commerce platform according to an analysis item;
a keyword retrieving module configured to retrieve a plurality of keywords in the comment data;
a sentiment analysis module comprising a plurality of sentiment groups, each of the sentiment groups comprising a plurality of feature phrases, the sentiment analysis module being configured to compare each of the keywords with the sentiment groups, wherein when a first feature phrase of the feature phrases in the sentiment groups matches with a first keyword of the keywords, the sentiment analysis module determines that the sentiment group having the first feature is a sentiment group corresponding to the first keyword, and increases a rating of the sentiment group corresponding to the first keyword; and
a reputation analysis module configured to select a plurality of first sentiment groups corresponding to the analysis item from the sentiment groups, and sum the ratings of the first sentiment groups.

2. The e-commerce reputation analysis system of claim 1, wherein when none of the feature phrases in the sentiment groups matches with the first keyword of the keywords, the sentiment analysis module translates the first keyword to generate a corresponding translated phrase in a language different from that used by the first keyword, and performs a similarity comparison between the corresponding translated phrase and the feature phrases of each of the sentiment groups, thereby generating a comparison result, wherein when determining that there exists the sentiment group corresponding to the first keyword according to the comparison result, the sentiment analysis module increases the rating of the sentiment group corresponding to the first keyword.

3. The e-commerce reputation analysis system of claim 2, wherein the sentiment analysis module performs the similarity comparison between the corresponding translated phrase and the feature phrases of each of the sentiment groups by using a unigram or bigram method.

4. The e-commerce reputation analysis system of claim 2, wherein when determining that there exists the sentiment group corresponding to the first keyword according to the comparison result, the sentiment analysis module further sets the first keyword as a second feature phrase, and adds the second feature phrase to the sentiment group corresponding to the first keyword, thereby updating the feature phrases included in the sentiment group corresponding to the first keyword.

5. The e-commerce reputation analysis system of claim 2, wherein the sentiment analysis module comprises a feature vocabulary used to store the feature phrases in each of the sentiment groups, wherein when determining that there exists the sentiment group corresponding to the first keyword according to the comparison result, the sentiment analysis module sets the first keyword as a second feature phrase, and adds the second feature phrase to the feature vocabulary.

6. The e-commerce reputation analysis system of claim 1, wherein the keyword retrieving module comprises:
a word segmentation unit configured to perform a word segmentation algorithm on contents of the comment data, thereby obtaining a plurality of phrase segments;
a word property recognition unit configured to recognize properties of the phrase segments; and
a word retrieving unit configured to retrieve the phrase segments having nouns and adjectives as a plurality of keyword candidates, and to retrieve the keywords from the keyword candidates.

7. The e-commerce reputation analysis system of claim 6, wherein the word retrieving unit retrieves the keywords according to appearing frequencies of the keyword candidates and correlations between the keyword candidates and the analysis item.

8. The e-commerce reputation analysis system of claim 1, wherein the analysis item is merchandise, a seller or an activity on the e-commerce platform.

9. An e-commerce reputation analysis method, comprising:
capturing comment data from an e-commerce platform according to an analysis item;
retrieving a plurality of keywords in the comment data;
comparing each of the keywords with the sentiment groups, wherein each of the sentiment groups comprises a plurality of feature phrases;
determining that the sentiment group having the first feature is a sentiment group corresponding to the first keyword when a first feature phrase of the feature phrases in the sentiment groups matches with a first keyword of the keywords;
increasing a rating of the sentiment group corresponding to the first keyword;
selecting a plurality of first sentiment groups corresponding to the analysis item from the sentiment groups; and
summing the ratings of the first sentiment groups.

10. The e-commerce reputation analysis method of claim 9, further comprising:
translating the first keyword to generate a corresponding translated phrase in a language different from that used by the first keyword when none of the feature phrases in the sentiment groups matches with the first keyword of the keywords;
performing a similarity comparison between the corresponding translated phrase and the feature phrases of each of the sentiment groups, thereby generating a comparison result; and
increasing the rating of the sentiment group corresponding to the first keyword when it is determined that there exists the sentiment group corresponding to the first keyword according to the comparison result.

11. The e-commerce reputation analysis method of claim 10, wherein the step of performing a similarity comparison between the corresponding translated phrase and the feature phrases of each of the sentiment groups comprises:
performing the similarity comparison between the corresponding translated phrase and the feature phrases of each of the sentiment groups by using a unigram or bigram method.

12. The e-commerce reputation analysis method of claim 10, wherein when it is determined that there exists the sentiment group corresponding to the first keyword according to the comparison result, the e-commerce reputation analysis method further comprises:
setting the first keyword as a second feature phrase; and
adding the second feature phrase to the sentiment group corresponding to the first keyword, thereby updating the feature phrases included in the sentiment group corresponding to the first keyword.

13. The e-commerce reputation analysis method of claim 10, wherein when it is determined that there exists the sentiment group corresponding to the first keyword according to the comparison result, the e-commerce reputation analysis method further comprises:
setting the first keyword as a second feature phrase; and
adding the second feature phrase to the feature vocabulary.

14. The e-commerce reputation analysis method of claim 9, wherein the step of retrieving the keywords in the comment data comprises:
performing a word segmentation algorithm on contents of the comment data, thereby obtaining a plurality of phrase segments;
recognizing properties of the phrase segments;
retrieving the phrase segments having nouns and adjectives as a plurality of keyword candidates; and
retrieving the keywords from the keyword candidates.

15. The e-commerce reputation analysis method of claim 14, wherein the step of retrieving the keywords from the keyword candidates comprises:
retrieving the keywords according to appearing frequencies of the keyword candidates and correlations between the keyword candidates and the analysis item.

16. The e-commerce reputation analysis method of claim 9, wherein the analysis item is merchandise, a seller or an activity on the e-commerce platform.

17. A non-transitory computer readable medium storing a computer program performing an e-commerce reputation analysis method, the e-commerce reputation analysis method comprising:
capturing comment data from an e-commerce platform according to an analysis item;
retrieving a plurality of keywords in the comment data;
comparing each of the keywords with the sentiment groups, wherein each of the sentiment groups comprises a plurality of feature phrases;
determining that the sentiment group having the first feature is a sentiment group corresponding to the first keyword when a first feature phrase of the feature phrases in the sentiment groups matches with a first keyword of the keywords;
increasing a rating of the sentiment group corresponding to the first keyword;
selecting a plurality of first sentiment groups corresponding to the analysis item from the sentiment groups; and
summing the ratings of the first sentiment groups.
